(19) United States
(12) Patent Application Publication
(10) Pub. No.: US 2026/0288630 A1
(43) Pub. Date: Sep. 24, 2026

(54) MEMORY SYSTEM

(71) Applicant: Kioxia Corporation, Tokyo (JP)

(72) Inventors: Shinichi MATSUKAWA, Shinagawa Tokyo (JP); Yasuyuki EGUCHI, Kawasaki Kanagawa (JP); Kazushi MIYAKE, Yokohama Kanagawa (JP)

(21) Appl. No.: 19/324,944

(22) Filed: Sep. 10, 2025

(30) Foreign Application Priority Data
Mar. 21, 2025 (JP) 2025-046864

(51) Int. Cl. G06F 12/02; G06F 12/1045

(52) U.S. Cl. CPC G06F 12/0246; G06F 12/1045; G06F 2212/454

(57) ABSTRACT

A memory system with high reading operation performance is provided. A memory system is connectable to a host device and includes a first memory device and a controller. The first memory device is a non-volatile memory including a first memory cell region assigned with a first consecutive physical address range and a second memory region separate from the first memory cell region and assigned with a second consecutive physical address range that is separate from the first consecutive physical address range. The controller is configured to store vector information received from the host device in the first memory cell region and not in the second memory cell region, and store non-vector information received from the host device in the second memory cell region and not in the first memory cell region.

### CROSS-REFERENCE TO RELATED APPLICATIONS

This application is based upon and claims the benefit of priority from Japanese Patent Application No. 2025-046864, filed Mar. 21, 2025, the entire contents of which are incorporated herein by reference.

### FIELD

Embodiments described herein relate generally to a memory system.

### BACKGROUND

In inference processing of generative artificial intelligence (AI), an operation of sequentially reading a large number of vector information pieces is performed. A memory system having a non-volatile flash memory can be applied as a storage for vector information to be used in generative AI.

### BRIEF DESCRIPTION OF THE DRAWINGS

FIG. 1 is a diagram schematically showing an example of a configuration of a memory system according to a first embodiment.

FIG. 2 is a diagram schematically showing an example of a configuration of a memory chip according to the first embodiment.

FIG. 3 is a diagram schematically showing a circuit configuration of a block according to the first embodiment.

FIG. 4 is a diagram illustrating logical-physical conversion information and an example of a method for storing vector information into a NAND memory according to the first embodiment.

FIG. 5 is a diagram illustrating an example of data to be stored in a NAND memory and a RAM according to the first embodiment.

FIG. 6 is a diagram illustrating an example of a caching method for data according to the first embodiment.

FIG. 7 is a diagram showing an example of a command format according to the first embodiment.

FIG. 8 is a flowchart showing an example of a writing operation of the memory system according to the first embodiment.

FIG. 9 is a flowchart showing an example of a reading operation of the memory system according to the first embodiment.

FIG. 10 is a diagram illustrating a method for determining a storage location of vector information according to a modification 1.

FIG. 11 is a diagram illustrating logical-physical conversion information and an example of a method for storing vector information into a NAND memory according to a second embodiment.

FIG. 12 is a diagram illustrating an example of data to be stored in a NAND memory and a RAM according to the second embodiment.

FIG. 13 is a flowchart showing an example of a writing operation of a memory system according to the second embodiment.

FIG. 14 is a flowchart showing an example of a reading operation of the memory system according to the second embodiment.

FIG. 15 is a diagram illustrating a first L2P table according to a modification 2.

### DETAILED DESCRIPTION

One or more embodiments are directed to providing a memory system having high reading operation performance.

In general, according to an embodiment, a memory system connectable to a host device includes a first memory device and a controller. The first memory device is a non-volatile memory including a first memory cell region assigned with a first consecutive physical address range and a second memory region separate from the first memory cell region and assigned with a second consecutive physical address range that is separate from the first consecutive physical address range. The controller is configured to store vector information received from the host device in the first memory cell region and not in the second memory cell region, and store non-vector information received from the host device in the second memory cell region and not in the first memory cell region.

Memory systems according to embodiments will be described in detail with reference to the accompanying drawings. It is noted that the present invention is not limited to these embodiments.

### First Embodiment

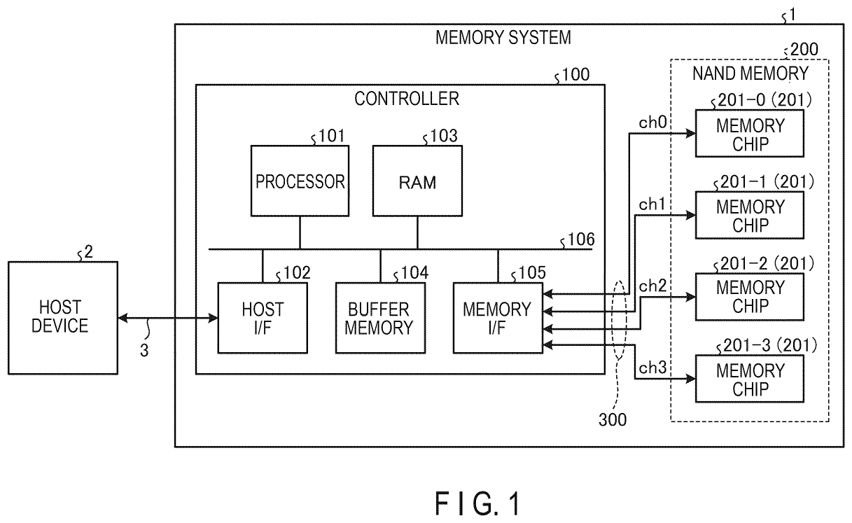

FIG. 1 is a diagram schematically showing an example of a configuration of a memory system 1 according to a first embodiment.

The memory system 1 is connected to a host device 2 via a communication interface 3. The host device 2 is, for example, a processor provided in an information processing device. The information processing device is, for example, a personal computer. The information processing device may be a cellular phone, a smartphone, a portable music player, an imaging device, or the like. The memory system 1 is, for example, a solid state drive (SSD). The standard of the communication interface 3 is not particularly limited.

The host device 2 executes processing of generative AI by executing a computer program. The host device 2 writes, into the memory system 1, a large number of vector information pieces to be used in the processing of generative AI. The processing of generative AI includes inference processing. During the inference processing, the host device 2 sequentially reads a plurality of vector information pieces from the memory system 1. For example, the host device 2 repeatedly executes a series of operations of reading one or more vector information pieces from the memory system 1 and performing a calculation using the one or more vector information pieces that have been read.

In addition to vector information, the host device 2 can write any data other than vector information into the memory system 1 or read the data from the memory system 1. Hereinafter, vector information is referred to as vector information Dv, and data other than vector information is referred to as non-vector information Dnv.

The host device 2 uses access commands (e.g., write commands and read commands) to access (e.g., write and read) the memory system 1.

The memory system 1 receives an access command from the host device 2. In response to a write command, the memory system 1 stores data requested to be written (hereafter, write data). In response to a read command, the memory system 1 transmits data requested to be read (hereafter, read data) to the host device 2.

The access command includes a logical address. The memory system 1 provides a logical address space to the host device 2. The logical address indicates a location in the logical address space. The host device 2 uses the logical address to specify the location where user data is written or user data is read. In other words, the logical address is location information to be used by the host device 2.

The memory system 1 includes a controller 100 and a NAND type flash memory (NAND memory) 200. The controller 100 is connected to the NAND memory 200 via a memory bus 300. The NAND memory 200 is an example of a first memory.

The controller 100 controls the NAND memory 200.

The controller 100 writes data requested to be written by the host device 2 into the NAND memory 200, and reads data requested to be read by the host device 2 from the NAND memory 200 and then sends the read data to the host device 2. In other words, the controller 100 transfers data between the host device 2 and the NAND memory 200.

The controller 100 includes a processor 101, a host interface circuit (host I/F) 102, a random access memory (RAM) 103, a buffer memory 104, a memory interface circuit (memory I/F) 105, and an internal bus 106. The processor 101, the host I/F 102, the RAM 103, the buffer memory 104, and the memory I/F 105 are electrically connected to the internal bus 106. The RAM 103 is an example of a second memory.

The controller 100 may be configured as a system-on-a-chip (SoC). Alternatively, the controller 100 may be configured by a plurality of chips. The controller 100 may also be configured as a field-programmable gate array (FPGA) or an application specific integrated circuit (ASIC). The RAM 103 or the buffer memory 104 may be arranged outside the controller 100.

The host I/F 102 receives access commands, data, etc. from the host device 2. The host I/F 102 also transmits data read from the NAND memory 200 and responses to access commands or the like to the host device 2.

The buffer memory 104 is a memory functioning as a buffer for data transfer between the host device 2 and the NAND memory 200. The buffer memory 104 is configured by a volatile memory such as a static random access memory (SRAM) or a dynamic random access memory (DRAM). It is noted that the type of the memory forming the buffer memory 104 is not limited to these memories. The buffer memory 104 may be configured by any type of non-volatile memory.

The memory I/F 105 controls the processing of write data, etc. into the NAND memory 200 and the processing of read data, etc. from the NAND memory 200 based on instructions from the processor 101.

The processor 101 is a circuit that can execute a computer program. The processor 101 is, for example, a central processing unit (CPU). The processor 101 integrally controls respective components of the controller 100 based on a firmware program that has been stored in advance at a predetermined location (for example, the NAND memory 200), thereby implementing various operations of the controller 100.

It is noted that a part or whole of the processing executed by the processor 101 may be executed by a dedicated hardware circuit.

The RAM 103 is a memory that can be used as a cache memory or a working memory by the processor 101. The RAM 103 is configured by DRAM, SRAM, or a combination thereof. It is noted that the type of the memory forming the RAM 103 is not limited to these memories.

The NAND memory 200 is a memory that can store data in a non-volatile manner. The NAND memory 200 is configured by one or more memory chips 201. Here, the NAND memory 200 is configured by four memory chips 201-0, 201-1, 201-2, and 201-3. The memory bus 300 has four channels ch0 to ch3, and one memory chip 201 is connected to each of the four channels ch0 to ch3. It is noted that the number of channels forming the memory bus 300 is not limited to four. The number of memory chips 201 connected to each channel is not limited to one.

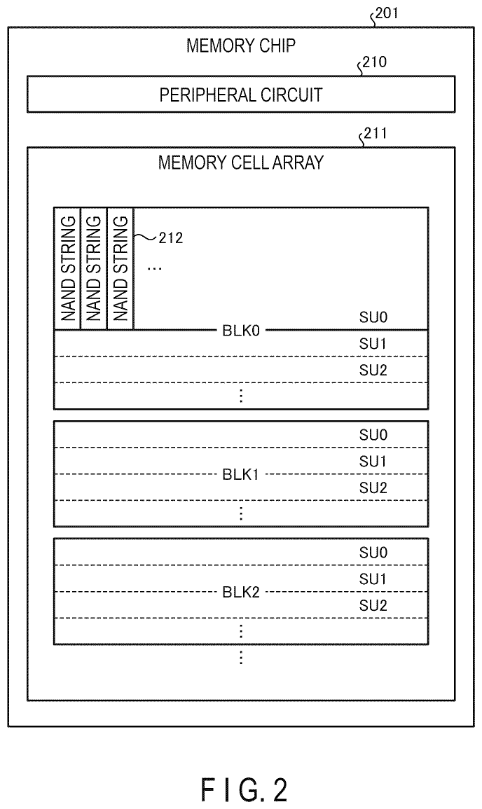

FIG. 2 is a diagram schematically showing an example of the configuration of the memory chip 201 according to the first embodiment. The memory chip 201 includes a peripheral circuit 210 and a memory cell array 211.

The memory cell array 211 includes a plurality of blocks BLK (BLK0, BLK1, BLK2, . . . ). Each block BLK includes a plurality of string units SU (SU0, SU1, SU2, . . . ). Each string unit SU includes a plurality of NAND strings 212. Each NAND string 212 includes a plurality of non-volatile memory cell transistors connected in series. It is noted that the number of the NAND strings 212 in the string unit SU is arbitrary. The number of the memory cell transistors in the NAND string 212 is arbitrary.

The peripheral circuit 210 includes, for example, a row decoder, a column decoder, a sense amplifier, a latch circuit, and a voltage generation circuit. In response to an instruction from the controller 100, the peripheral circuit 210 executes an operation corresponding to the instruction on the memory cell array 211. The instruction from the controller 100 includes write, read, and erase.

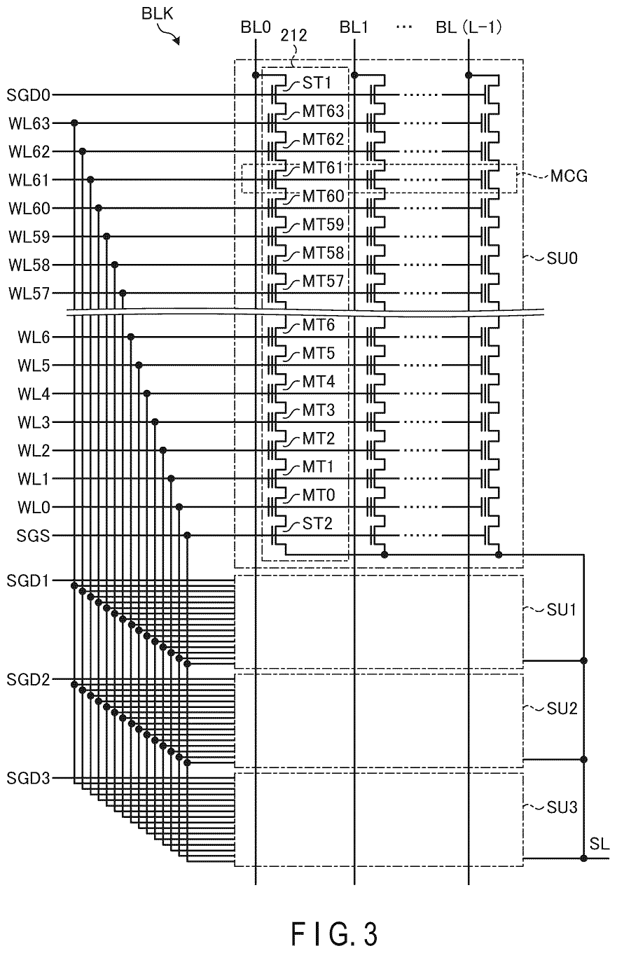

FIG. 3 is a schematic diagram showing the circuit configuration of a block BLK according to the first embodiment. It is noted that the respective block BLKs have the same configuration. The block BLK has, for example, four string units SU0 to SU3. Each string unit SU includes a plurality of NAND strings 212.

Each of the NAND strings 212 includes, for example, 64 memory cell transistors MT (MT0 to MT63) and select transistors ST1 and ST2. The memory cell transistor MT has a control gate and a charge accumulation layer, and stores data in a non-volatile manner. The 64 memory cell transistors MT (MT0 to MT63) are connected in series between the source of the select transistor ST1 and the drain of the select transistor ST2. It is noted that the memory cell transistor MT may be of metal-oxide-nitride-oxide-silicon (MONOS) type which uses an insulating film for the charge accumulation layer, or of floating gate (FG) type which uses a conductive film for the charge accumulation layer. Furthermore, the number of the memory cell transistors MT in the NAND string 212 is not limited to 64.

The gate of the select transistor ST1 in each of the string units SU0 to SU3 is connected to each of the select gate lines SGD0 to SGD3. In contrast, the gate of the select transistor ST2 in each of the string units SU0 to SU3 is commonly connected to, for example, a select gate line SGS. The gate of the select transistor ST2 in each of the string units SU0 to SU3 may be connected to different select gate lines SGS0 to SGS3 (not shown) for the respective string units SU. The control gates of the memory cell transistors MT0 to MT63 in the same block BLK are commonly connected to the respective word lines WL0 to WL63.

The drains of the select transistors ST1 of the NAND strings 212 in the string unit SU are connected to different bit lines BL (BL0 to BL(L−1), where L represents a natural number of 2 or more). The bit line BL commonly connects one NAND string 212 in each string unit SU among a plurality of blocks BLK. Furthermore, the sources of the select transistors ST2 are commonly connected to a source line SL.

In other words, the string unit SU is a set of a plurality of NAND strings 212 that are connected to different bit lines BL and the same select gate line SGD. The block BLK is a set of a plurality of string units SU that share word lines WL. The memory cell array 211 is a set of a plurality of blocks BLK that share at least one bit line BL.

Writing and reading by the peripheral circuit 210 can be collectively performed on the memory cell transistors MT connected to one word line WL in one string unit SU. A group of memory cell transistors MT to be collectively selected for writing and reading is referred to as a memory cell group MCG. A unit of a set of 1-bit storage areas to be written into or read from one memory cell group MCG is referred to as a page.

Erasing by the peripheral circuit 210 is performed on a block BLK basis. In other words, all data stored in one block BLK is collectively erased.

The configuration of the memory cell array 211 is not limited to the configuration shown in FIGS. 2 and 3. For example, the memory cell array 211 may have a configuration in which the NAND strings 212 are arranged two-dimensionally or three-dimensionally.

A plurality of physical addresses that are different from one another among locations in the memory cell array 211 is assigned to a data-storable region of the memory cell array 211 equipped in each memory chip 201. In other words, locations in a physical address space PSP correspond to locations in a storage area configured by the memory cell arrays 211 of the memory chips 201-1 to 201-3. For example, each physical address corresponds to a combination of a memory chip 201, a block BLK, a string unit SU, a memory cell group MCG, a page, and a position within the page. The space configured by the plurality of physical addresses described above is referred to as the physical address space PSP.

The controller 100 manages and maintains logical-physical conversion information (may be referred to as logical-physical address mapping information) for associating a logical address with a physical address (e.g., a logical address is mapped to/from a physical address). The logical-physical conversion information is configured such that when a logical address is used to search, the physical address associated with the logical address can be obtained.

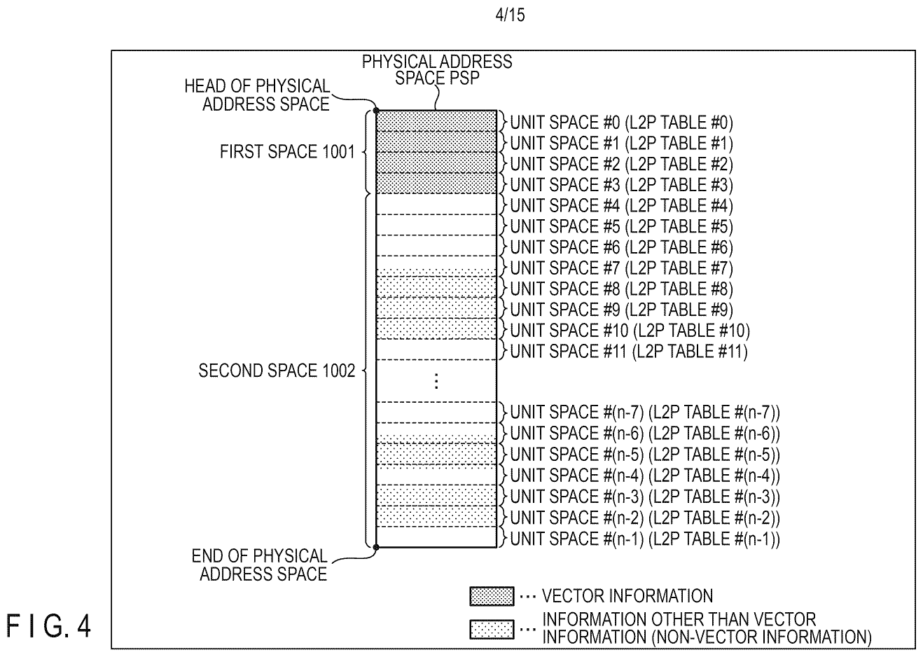

FIG. 4 is a diagram illustrating the logical-physical conversion information according to the first embodiment and an example of a method for storing vector information Dv in the NAND memory 200.

The logical-physical conversion information includes a plurality of L2P tables 301 each of which covers a predetermined physical address range and may be referred to as a mapping segment or subsegment. Covering a physical address range means that the correspondence relations between logical addresses and physical addresses can be managed for all physical addresses included in the physical address range. The physical address space PSP is divided into a plurality of unit spaces for each physical address range. The correspondence relations between logical addresses and physical addresses are stored in an L2P table 301 which differs on a unit-space basis. In other words, one L2P table 301 is configured to indicate the correspondence relations between logical addresses and physical addresses for one or more physical addresses included in the unit space corresponding to the L2P table 301.

In an example shown in FIG. 4, the physical address space PSP is divided into n (n represents an integer of 5 or more) unit spaces #0 to #(n−1), and the correspondence relations between logical addresses and physical addresses included in the physical address space PSP are managed by n L2P tables 301. It is noted that in FIG. 4, the L2P table 301 in which the correspondence relations between the logical addresses and the physical addresses included in the unit space #X (X is numerical information) are stored is expressed as L2P table #X.

Each L2P table 301 is a data unit for caching in the RAM 103 (more precisely, an L2P table cache area 410 described below). In other words, the logical-physical conversion information is stored or refilled in the RAM 103 for each L2P table 301.

A technique to be compared with the first embodiment will be described. The technique to be compared with the first embodiment is expressed as a comparative example. According to the comparative example, a physical address indicating a storage destination of write data received from the host device is determined regardless of whether the write data is vector information or not. Therefore, the physical addresses indicating storage destinations for a plurality of vector information pieces can be distributed throughout the entire physical address space. In other words, when only the vector information is focused on, there are a large number of L2P tables that can be referenced to identify the physical addresses indicating storage destinations for a plurality of vector information pieces.

As described above, the L2P table is a data unit for caching in RAM. When reading of vector information is requested by a host device, but there is no hit for the L2P table cached in the RAM (that is, the L2P table cached in the RAM is not for the address range corresponding to a storage location of the requested vector information), the controller refills the L2P table. In other words, the controller reads another L2P table from the NAND memory and replaces the L2P table in the RAM with the read L2P table. When the L2P table is refilled, the latency of the reading operation as seen from the host device increases by the amount of time spent on the refill.

According to the comparative example, there are many L2P tables for managing the locations of the storage destinations of a plurality of vector information pieces. Therefore, when the host device sequentially requests to read a plurality of vector information pieces, the probability of hitting the L2P table cached in the RAM is low. Therefore, when the host device sequentially requests to read a plurality of vector information pieces, there is a high probability that refilling of the L2P table occurs, which increases the latency of the reading operation as seen from the host device. In other words, the performance of the reading operation as seen from the host device is poor.

To address such an issue, in the first embodiment, the physical addresses indicating the storage destinations for the plurality of vector information pieces Dv are determined from a space covered by limited some of the plurality of L2P tables 301 in the physical address space PSP (a first space 1001 in the example shown in FIG. 4). When only the vector information Dv is focused on, the number of L2P tables 301 that can be referred to for identifying the physical addresses indicating the storage destination of the plurality of vector information pieces Dv is reduced as compared with the comparative example. Therefore, the probability of hitting the L2P table 301 cached in the RAM 103 when the host device 2 sequentially requests to read the plurality of vector information pieces Dv is enhanced as compared with the comparative example, and the probability that refilling of the L2P table 301 occurs is reduced as compared with the comparative example. As a result, the latency of the reading operation as seen from the host device 2 is restrained from increasing as compared with the comparative example. In other words, the read performance as seen from the host device 2 is enhanced.

In the example shown in FIG. 4, the first space 1001 is configured by unit spaces #0 to #3 covered by L2P tables #0 to #3 of the n L2P tables 301. The physical addresses of storage destinations of non-vector information Dnv are determined from a second space 1002 configured by unit spaces #4 to #(n-1). The physical addresses of the storage destinations of all the vector information pieces Dv are therefore managed only with the L2P tables #0 to #3 of the n L2P tables 301. When the host device 2 sequentially requests to read a plurality of vector information pieces Dv, the probability of hitting the L2P table 301 when reading each vector information piece Dv is approximately ¼.

In contrast, when the comparative example is applied, the physical addresses of the storage destinations of all the vector information pieces can be managed with being distributed to n L2P tables which is larger than four. Therefore, when the host device sequentially requests to read a plurality of vector information pieces Dv, the probability of hitting the L2P table when reading each vector information piece may be 1/n which is lower than ¼.

In other words, according to the first embodiment, the probability of hitting the L2P table 301 being cached in the RAM 103 is enhanced from 1/n to ¼, and the performance of the reading operation as seen from the host device 2 is improved in accordance with the enhancement of the probability.

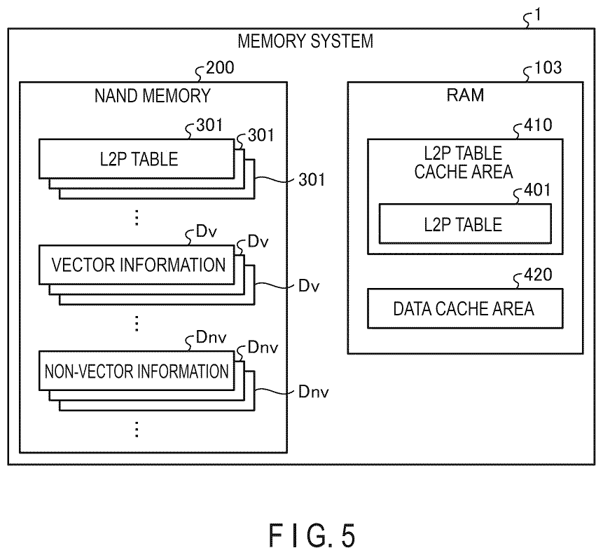

FIG. 5 is a diagram illustrating an example of data stored in the NAND memory 200 and the RAM 103 according to the first embodiment.

The plurality of L2P tables 301, the vector information Dv, and the non-vector information Dnv are stored in the NAND memory 200.

The plurality of L2P tables 301 are logical-physical conversion information pieces each of which covers a different unit space.

The RAM 103 is provided with the L2P table cache area 410. One of the plurality of L2P tables 301 is cached in the L2P table cache area 410. The L2P table 301 cached in the L2P table cache area 410 is expressed as an L2P table 401.

It is noted that the number of L2P tables 301 that can be cached in the L2P table cache area 410 is not limited to one. Two or more L2P tables 301 may be cached in the L2P table cache area 410.

The RAM 103 is further provided with a data cache area 420. The data read from the NAND memory 200 is cached in the data cache area 420. In the first embodiment, reading of data from the NAND memory 200 is performed on a page basis. The data read on a page basis is cached in the data cache area 420.

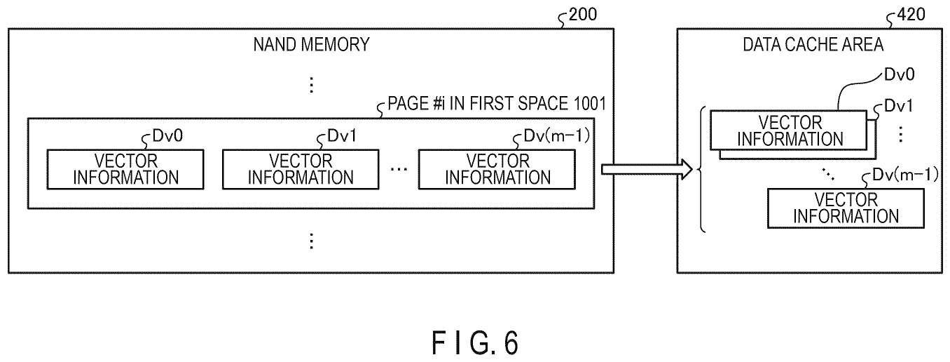

FIG. 6 is a diagram illustrating an example of a method for caching data according to the first embodiment.

The controller 100 can store a plurality of vector information pieces Dv in each page whose physical addresses are included in the first space 1001. When reading of one vector information piece Dv is requested from the host device 2, the controller 100 reads all vector information pieces Dv from a page in which the vector information pieces Dv requested to be read are stored, and caches all of the read vector information pieces Dv into the data cache area 420.

In an example shown in FIG. 6, m vector information pieces Dv0 to Dv(m−1) are stored in a certain page #i. When reading of one of the vector information pieces Dv0 to Dv(m−1) is requested from the host device 2, the controller 100 reads the vector information pieces Dv0 to Dv(m−1) from page #i, and stores the read vector information pieces Dv0 to Dv(m−1) into the data cache area 420.

When the host device 2 repeatedly reads the vector information Dv from the memory system 1 in the inference processing, the controller 100 reads a narrow range within the physical address space PSP. Therefore, a plurality of vector information pieces Dv including vector information pieces Dv requested to be read are read on a page basis, and cached into the data cache area 420, thereby enhancing the probability that vector information Dv when reading of a plurality of vector information pieces Dv is sequentially requested is hit in the data cache area 420, which further improves the reading performance as seen from the host device 2.

When the host device 2 transmits write data to the memory system 1, the host device 2 can know whether the write data corresponds to vector information Dv or non-vector information Dnv.

In one example, the host device 2 includes a driver section for controlling hardware, a file system section, and an application section for executing generative AI processing. These sections are implemented by a processor included in the host device 2 executing specific computer programs. When the application section performs writing or reading, the application section notifies the file system section of whether write data or read data corresponds to vector information Dv. The file system section informs the driver section of whether the write data or the read data corresponds to the vector information Dv. The driver section issues a write command or a read command to the memory system 1 after recognizing whether the write data or the read data corresponds to the vector information Dv. It is noted that a method by which the host device 2 recognizes whether the write data corresponds to vector information Dv or non-vector information Dnv is not limited to this method.

When the host device 2 transmits a write command to the memory system 1, the host device 2 notifies the memory system 1 of whether the write data corresponds to vector information Dv or corresponds to non-vector information Dnv. A method by which the host device 2 notifies of whether write data corresponds to vector information Dv or corresponds to non-vector information Dnv is arbitrary. As one example, the host device 2 uses a specific parameter included in a write command to notify of whether write data corresponds to vector information Dv or corresponds to non-vector information Dnv.

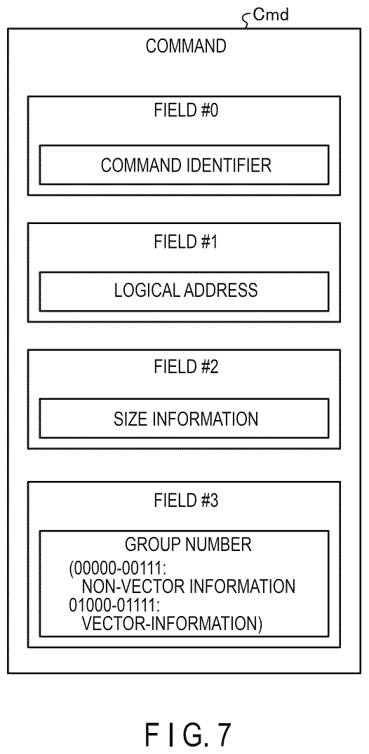

FIG. 7 is a diagram showing an example of the format of a command Cmd according to the first embodiment.

The command Cmd includes a field #0 in which a command identifier is set, a field #1 in which a logical address is set, a field #2 in which size information is set, and a field #3 in which a group number is set.

In the case of a write command, a command identifier of the write command is set in the field #0. A logical address indicating the location of write target data in a logical address space is set in the field #1. The size of the write data is set in the field #2. When the write data corresponds to vector information Dv, a value from 01000 to 01111 is set in the field #3. When the write data corresponds to non-vector information Dnv, a value from 00000 to 00111 is set in the field #3.

When the controller 100 receives a write command, the controller 100 refers to the group number set in the field #3 of the write command to recognize whether the write data corresponds to vector information Dv or corresponds to non-vector information Dnv.

It is noted that the format of the command Cmd shown in FIG. 7 may also be used in a read command. However, in the first embodiment, the format of the read command is not limited to this format.

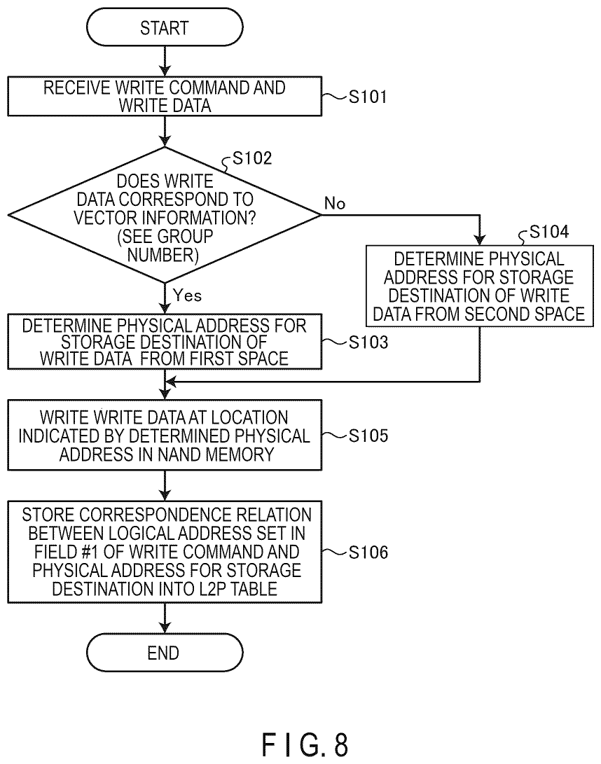

FIG. 8 is a flowchart showing an example of the writing operation of the memory system 1 according to the first embodiment.

When the memory system 1 receives a write command and write data from the host device 2 (S101), the controller 100 refers to the group number set in field #3 of the write command to determine whether the write data corresponds to vector information Dv or not (S102).

When the write data corresponds to vector information Dv (S102: Yes), the controller 100 determines a physical address indicating a storage destination for the write data from the first space 1001 (S103).

When the write data does not correspond to vector information Dv (S102: No), that is, when the write data corresponds to non-vector information Dnv, the controller 100 determines a physical address indicating a storage destination for the write data from the second space 1002 (S104).

After the processing of step S103 or step S104, the controller 100 writes the write data at a location indicated by the determined physical address in the NAND memory 200 (S105).

The controller 100 stores the correspondence relation between the logical address set in the field #1 of the write command and the physical address indicating the storage destination for the write data into the L2P table 301 (S106). Thereafter, the writing operation is terminated.

In step S106, a method for storing the correspondence relation into the L2P table 301 is not limited to a specific method. In one example, the controller 100 reads the L2P table 301 covering the unit space including the physical address indicating the storage destination for the write data from the NAND memory 200, and stores the above correspondence relation into the read L2P table 301. Thereafter, the controller 100 writes the L2P table 301 having the correspondence relation stored therein into the NAND memory 200.

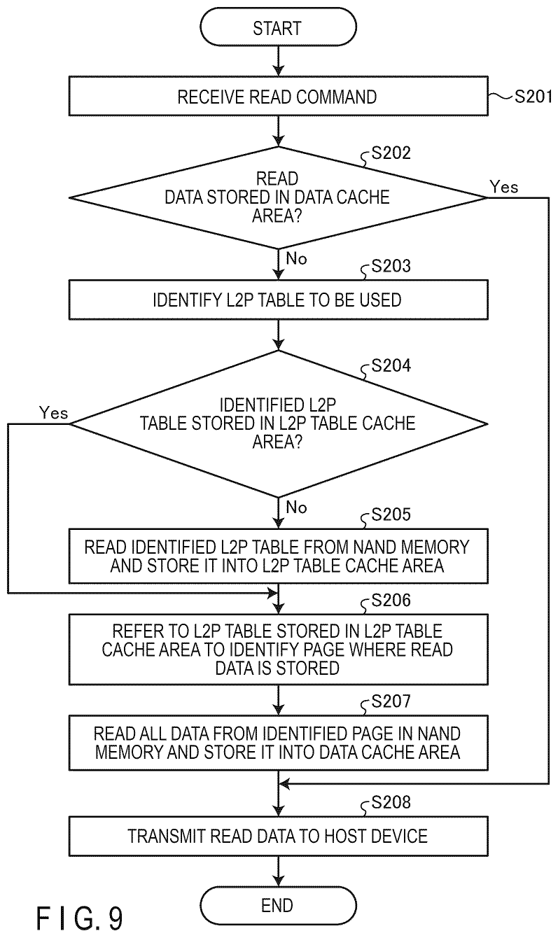

FIG. 9 is a flowchart showing an example of a reading operation of the memory system 1 according to the first embodiment.

When the memory system 1 receives a read command from the host device 2 (S201), the memory system 1 determines whether read data is stored in the data cache area 420 (S202).

When read data is not stored in the data cache area 420 (S202: No), the controller 100 identifies an L2P table 301 in which the correspondence relation between the logical address set in field #1 of the read command, that is, the logical address indicating the location of the read data, and the physical address is stored (S203).

The controller 100 determines whether the identified L2P table 301 is stored in the L2P table cache area 410 (S204). When the identified L2P table 301 is not stored in the L2P table cache area 410 (S204: No), that is, when a cache miss occurs, the controller 100 reads the identified L2P table 301 from the NAND memory 200 and stores it into the L2P table cache area 410 (S205). In other words, the controller 100 refills the L2P table 301.

When the identified L2P table 301 is stored in the L2P table cache area 410 (S204: Yes), or after the processing of step S205, the controller 100 refers to an L2P table 401 stored in the L2P table cache area 410, which is the identified L2P table 301, to identify a page in which the read data is stored (S206).

The controller 100 reads all data from the identified page in the NAND memory 200, and stores the read data into the data cache area 420 (S207). The controller 100 transmits the read data to the host device 2 (S208). Then, the reading operation is terminated.

When the read data is stored in the data cache area 420 (S202: Yes), the control shifts to step S208, and the controller 100 transmits the read data stored in the data cache area 420 to the host device 2. Then, the reading operation is terminated.

As described above, according to the first embodiment, the controller 100 stores the vector information Dv into a storage area in the NAND memory 200 which corresponds to the first space 1001 consisting of a group of consecutive physical addresses in the physical address space PSP. The controller 100 stores non-vector information Dnv into a storage area indicated by a physical address which is different from the first space 1001 in the physical address space PSP (a storage area corresponding to the second space 1002 in the above example).

Therefore, when only the vector information Dv is focused on, it is possible to reduce the number of L2P tables 301 to be referred to as compared with the comparative example. As a result, this reduces the probability that refilling of the L2P table 301 occurs when reading of a plurality of vector information pieces Dv are sequentially requested from the host device 2, so that the reading performance as seen from the host device 2 when the host device 2 performs the processing of the generative AI is improved.

According to the first embodiment, the controller 100 divides logical-physical conversion information into a plurality of L2P tables 301 indicating the correspondence relations between logical addresses and physical addresses for physical addresses that are respectively included in different unit spaces, and stores the divided L2P tables into the NAND memory 200. The controller 100 stores one of the plurality of L2P tables 301 into the L2P table cache area 410. As described above, the controller 100 may store two or more L2P tables 301 into the L2P table cache area 410. When a read command including a logical address indicating the location of read data is received from the host device 2, the controller 100 determines whether a target L2P table 301 in which the correspondence relation between the logical address indicating the location of the read data and the physical address is described is stored in the L2P table cache area 410. When the target L2P table 301 is stored in the L2P table cache area 410, the controller 100 identifies the physical address corresponding to the logical address indicating the location of the read data based on the target L2P table 301 stored in the L2P table cache area 410. When the target L2P table 301 is not stored in the L2P table cache area 410, the controller 100 refills the target L2P table 301, and identifies the physical address corresponding to the logical address indicating the location of the read data based on the target L2P table 301. The controller 100 reads the read data from the location indicated by the identified physical address, and transmits the read data to the host device 2.

Therefore, when only the vector information Dv is focused on, the number of L2P tables 301 that can be referred to can be reduced as compared with the comparative example. Therefore, the reading performance as seen from the host device 2 when the host device 2 performs the processing of the generative AI is improved.

Furthermore, according to the first embodiment, the controller 100 stores a plurality of vector information pieces Dv into each page included in the first space 1001. The controller 100 reads data from the NAND memory 200 on a page basis, and stores the read page-based data into the data cache area 420. When reading of read data corresponding to vector information Dv is requested and the read data is stored in the data cache area 420, the controller 100 transmits the read data stored in the data cache area 420 to the host device 2. When the read data is not stored in the data cache area 420, the controller 100 determines whether the target L2P table 301 is stored in the L2P table cache area 410.

Therefore, when reading of a plurality of vector information pieces Dv is sequentially requested from the host device 2, it is possible to enhance the probability of a cache hit in the data cache area 420. Therefore, the reading performance as seen from the host device 2 when the host device 2 performs the processing of the generative AI is improved.

In the above example, the controller 100 reads data from the NAND memory 200 on a page basis, and stores the read data into the data cache area 420 regardless of whether the read data corresponds to vector information Dv. The controller 100 may read data from the NAND memory 200 on a page basis and store the read data into the data cache area 420 when the read data corresponds to vector information Dv, and may read only read data from the NAND memory 200 and store the read data into the data cache area 420 when the read data corresponds to non-vector information Dnv.

Furthermore, according to the first embodiment, the write command includes the field #3 in which a group number (an example of a first parameter value) is set. Based on the group number set in the field #3, the controller 100 determines whether the write data corresponds to vector information Dv or corresponds to non-vector information Dnv.

It is noted that a method of determining whether the write data corresponds to vector information Dv or corresponds to non-vector information Dnv is not limited to the above method.

### Modification 1

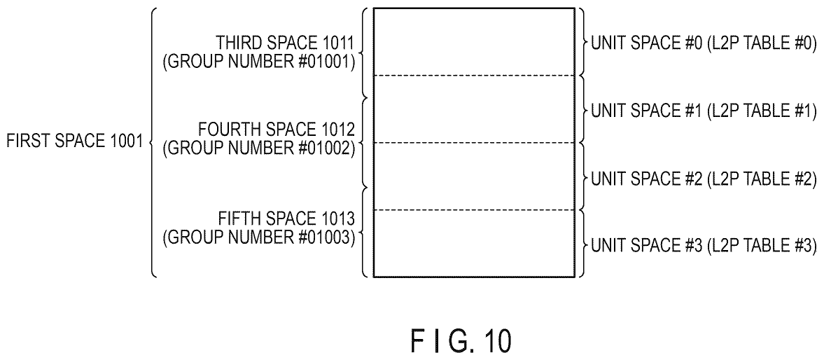

A modification 1 of the first embodiment will be described. FIG. 10 is a diagram illustrating a method for determining a storage location of vector information Dv according to the modification 1.

As described with reference to FIG. 7, when the write data corresponds to vector information Dv, the host device 2 sets a number from 01000 to 01111 in the field #3 of the write command.

The controller 100 may divide the first space 1001 into a plurality of partial spaces each consisting of consecutive physical addresses, and determine a physical address indicating a storage destination of write data from a different partial space for each group number.

In an example shown in FIG. 10, the first space 1001 is divided into a third space 1011, a fourth space 1012, and a fifth space 1013. When the group number set in the field #3 of a write command is 01001, the controller 100 determines the physical address indicating the storage destination for the write data from the third space 1011. When the group number set in the field #3 of the write command is 01002, the controller 100 determines the physical address indicating the storage destination for the write data from the fourth space 1012. When the group number set in the field #3 of the write command is 01003, the controller 100 determines the physical address indicating the storage destination for the write data from the fifth space 1013.

For example, when a plurality of vector information pieces Dv that are positionally close to one another are written, the host device 2 can use a common value as a group number. When the group number is used in this way, according to the modification 1, the plurality of vector information pieces Dv that are positionally close to one another are written at locations indicated by physical addresses that are also positionally close to one another in the physical address space PSP. Therefore, a L2P table 301 to be referred to when the plurality of vector information pieces Dv are read can be made as common as possible.

In the inference processing of the generative AI, there is a tendency to sequentially read vector information pieces Dv that are positionally close to one another. Since the L2P table 301 to be referred to when the plurality of vector information pieces Dv that are positionally close to one another is read is made as common as possible, the probability of a cache hit in the data cache area 420 can be enhanced when the host device 2 sequentially requests the reading of the plurality of vector information pieces Dv. Therefore, the reading performance as seen from the host device 2 when the host device 2 performs the processing of the generative AI is improved.

### Second Embodiment

In the first embodiment, a physical address indicating the location of a storage destination of vector information Dv is selected from the first space 1001 consisting of consecutive physical address groups. The first space 1001 consists of one or more unit spaces each covered by a different L2P table 301. As a result, the correspondence information indicating the correspondence relations between the logical addresses and the physical addresses for the storage destinations of vector information pieces Dv is collectively managed in one or more L2P tables 301 covering the unit areas forming the first space 1001.

In a second embodiment, another method is described in which correspondence information indicating the correspondence relations between the logical addresses and the physical addresses for the storage destinations of vector information pieces Dv is collectively managed in a specific L2P table 301. A memory system 1 according to the second embodiment is expressed as a memory system 1a, and the controller 100 according to the second embodiment is expressed as a controller 100a.

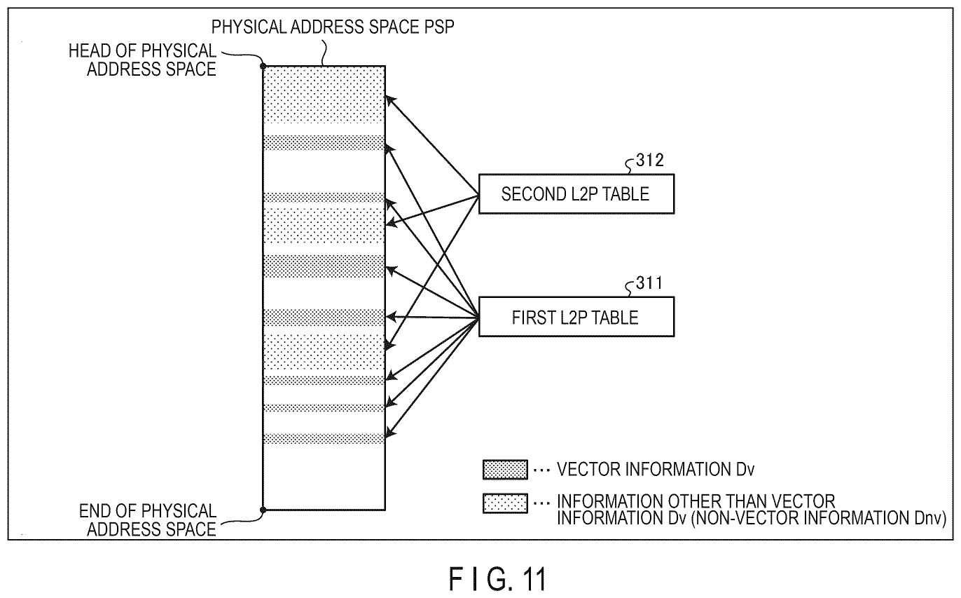

FIG. 11 is a diagram illustrating logical-physical conversion information according to the second embodiment and an example of a method for storing vector information Dv into the NAND memory 200.

In the second embodiment, as shown in FIG. 11, unlike the first embodiment, physical addresses indicating storage destinations of vector information Dv and physical addresses indicating storage destinations of non-vector information Dnv are arbitrarily determined, and the vector information Dv and the non-vector information Dnv are stored in the NAND memory 200 in a commingled manner. However, the storage destinations of the vector information Dv and the storage destinations of the non-vector information Dnv are managed by different L2P tables. Specifically, the correspondence relations between the logical addresses and the physical addresses indicating the storage destinations of the vector information Dv are managed by a first L2P table 311, and the correspondence relations between the logical addresses and the physical addresses indicating the storage destinations of the non-vector information Dnv are managed by a second L2P table 312. Each of the L2P tables 311 and 312 is a data unit to be cached in the L2P table cache area 410. The number of first L2P tables 311 to be used by the controller 100a and the number of second L2P tables 312 to be used by the controller 100a are both arbitrary. When the controller 100a uses a plurality of first L2P tables 311, the correspondence relation between the logical address and the physical address is stored for at least one physical address in each of the first L2P tables 311. When the controller 100a uses a plurality of second L2P tables 312, the correspondence relation between the logical address and the physical address is stored for at least one physical address in each of the second L2P tables 312.

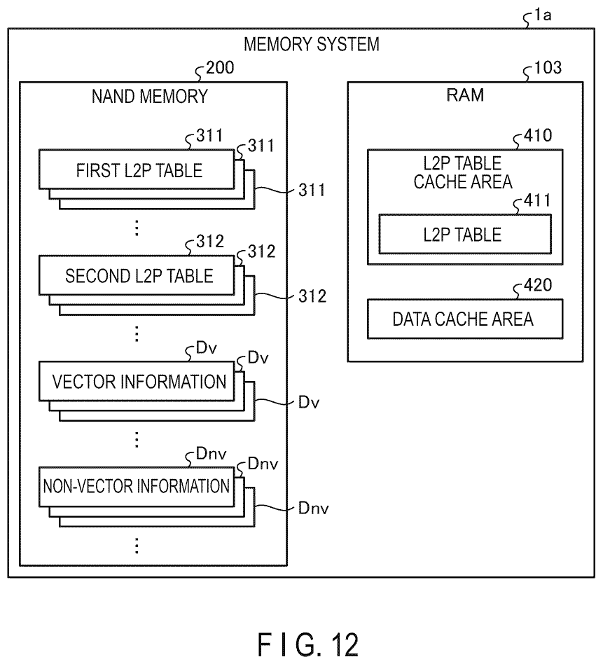

FIG. 12 is a diagram illustrating an example of data to be stored in the NAND memory 200 and the RAM 103 according to the second embodiment.

The NAND memory 200 stores one or more first L2P tables 311, one or more second L2P tables 312, vector information Dv, and non-vector information Dnv.

The RAM 103 is provided with an L2P table cache area 410 and a data cache area 420. One first L2P table 311 or one second L2P table 312 is cached in the L2P table cache area 410. The first L2P table 311 or the second L2P table 312 cached in the L2P table cache area 410 is expressed as an L2P table 411.

The numbers of L2P tables 311, 312 that can be cached in the L2P table cache area 410 are not limited to one. Two or more L2P tables 311, 312 may be cached in the L2P table cache area 410. When two or more L2P tables 311, 312 are cached in the L2P table cache area 410, the first L2P table 311 and the second L2P table 312 may or may not be mixed in the L2P table cache area 410.

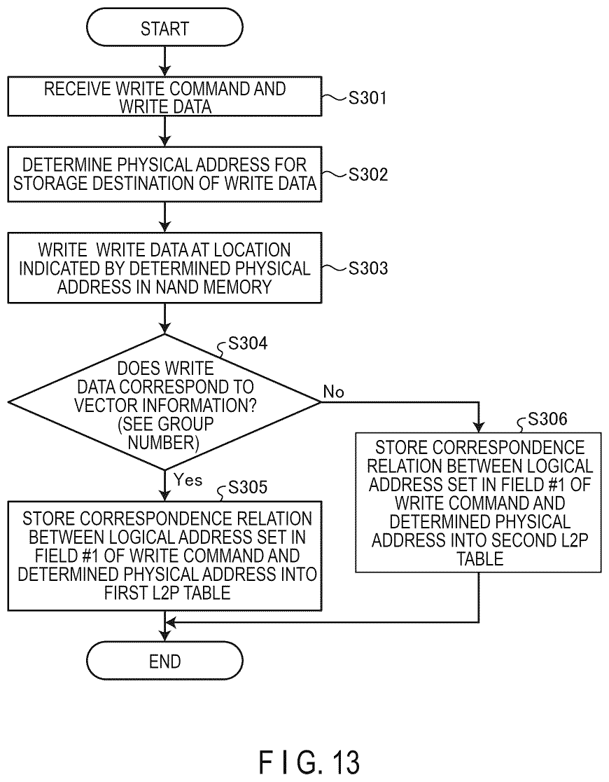

FIG. 13 is a flowchart showing an example of a writing operation of the memory system 1a according to the second embodiment.

When the memory system 1a receives a write command and write data from the host device 2 (S301), the controller 100a determines a physical address indicating a storage destination for the write data (S302).

As described above, unlike the first embodiment, the controller 100a can determine the physical address indicating the storage destination for the write data in any manner regardless of whether the write data corresponds to vector information Dv.

The controller 100a writes the write data at a location indicated by the determined physical address in the NAND memory 200 (S303).

The controller 100a refers to a group number set in the field #3 of the write command to determine whether the write data corresponds to vector information Dv (S304).

When the write data corresponds to vector information Dv (S304: Yes), the controller 100a stores the correspondence relation between the logical address set in the field #1 of the write command and the physical address indicating the storage destination for the write data into the first L2P table 311 (S305). Then, the writing operation is terminated.

When the write data does not correspond to vector information Dv (S304: No), i.e., when the write data corresponds to non-vector information Dnv, the controller 100a stores the correspondence relation between the logical address set in the field #1 of the write command and the physical address indicating the storage destination for the write data into the second L2P table 312 (S306). Then, the writing operation is terminated.

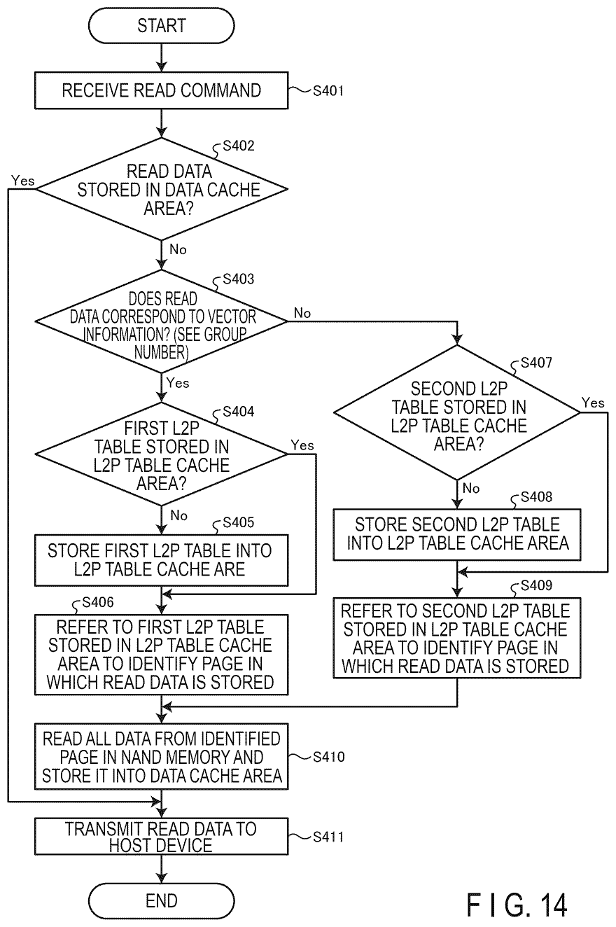

FIG. 14 is a flowchart showing an example of a reading operation of the memory system 1a according to the second embodiment.

When the memory system 1a receives a read command from the host device 2 (S401), the controller 100a determines whether read data is stored in the data cache area 420 (S402).

When the read data is not stored in the data cache area 420 (S402: No), the controller 100a refers to a group number set in the field #3 of the read command to determine whether the read data corresponds to vector information Dv (S403).

In this case, it is assumed that the read command has the format of the command Cmd shown in FIG. 7 and is configured such that whether the read data corresponds to non-vector information Dnv can be determined based on the group number set in the field #3. It is noted that a method by which the host device 2 notifies the memory system 1a of whether the read data corresponds to non-vector information Dnv during the reading operation is not limited to the above method.

When the read data corresponds to vector information Dv (S403: Yes), the controller 100a determines whether a first L2P table 311, more specifically, a target first L2P table 311 in which the correspondence relation between the physical address and the logical address indicating the location of the read data set in the field #1 of the read command is stored is stored in the L2P table cache area 410 (S404).

When the first L2P table 311 is not stored in the L2P table cache area 410 (S404: No), i.e., when a cache miss occurs, the controller 100a reads the first L2P table 311 from the NAND memory 200, and stores it into the L2P table cache area 410 (S405).

When the first L2P table 311 is stored in the L2P table cache area 410 (S404: Yes), or after the processing of step S405, the controller 100a refers to the L2P table 411, i.e., the first L2P table 311 stored in the L2P table cache area 410 to identify a page in which the read data is stored (S406).

When the read data does not correspond to vector information Dv (S403: No), the controller 100a determines whether the second L2P table 312, more specifically, the target second L2P table 312 in which the correspondence relation between the physical address and the logical address indicating the location of the read data set in the field #1 of the read command is stored is stored in the L2P table cache area 410 (S407).

When the second L2P table 312 is not stored in the L2P table cache area 410 (S407: No), the controller 100a reads the second L2P table 312 from the NAND memory 200, and stores it into the L2P table cache area 410 (S408).

When the second L2P table 312 is stored in the L2P table cache area 410 (S407: Yes), or after the processing of step S408, the controller 100a refers to the L2P table 411, i.e., the second L2P table 312 stored in the L2P table cache area 410 to identify a page in which the read data is stored (S409).

After the processing of step S406 or step S409, the controller 100a reads all data from the identified page in the NAND memory 200, and stores the read data into the data cache area 420 (S410). The controller 100a transmits the read data to the host device 2 (S411). Then, the reading operation is terminated.

When the read data is stored in the data cache area 420 (S402: Yes), the control shifts to step S411, and the controller 100 transmits the read data stored in the data cache area 420 to the host device 2. Then, the reading operation is terminated.

As described above, according to the second embodiment, the controller 100a stores the correspondence relation between the logical address and the physical address indicating the storage destination for the vector information Dv received from the host device 2 into the first L2P table 311. The controller 100a stores the correspondence relation between the logical address and the physical address indicating the storage destination for non-vector information Dnv received from the host device 2 into the second L2P table 312 which is different from the first L2P table 311.

Therefore, as in the first embodiment, when only the vector information Dv is focused on, the number of L2P tables 311 that can be referred to can be reduced as compared with the comparative example. As a result, the probability that the L2P table 301a is refilled when the host device 2 sequentially requests reading of a plurality of vector information pieces Dv is reduced, thereby improving the reading performance as seen from the host device 2 when the host device 2 performs the processing of the generative AI.

Furthermore, according to the second embodiment, the write command includes a field #3 in which a group number (an example of a first parameter value) is set. The controller 100a determines, based on the group number set in field #3, whether the write data corresponds to vector information Dv or non-vector information Dnv.

It is noted that a method for determining whether the write data corresponds to vector information Dv or corresponds to non-vector information Dnv is not limited to the above method.

Furthermore, according to the second embodiment, the read command has a field #3 in which a group number (an example of a first parameter value) is set. Based on a group number set in the field #3, the controller 100a determines whether the corresponding L2P tables 311, 312 are cached in the L2P table cache area 410.

A method of determining whether the read data corresponds to vector information Dv or corresponds to non-vector information Dnv is not limited to the above method.

### Modification 2

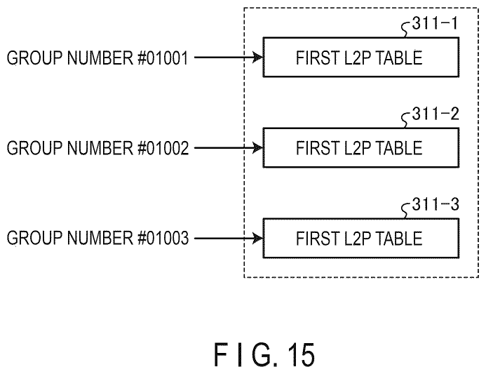

A modification 2 which is a modification of the second embodiment will be described below. FIG. 15 is a diagram illustrating a first L2P table 311 according to the modification 2.

The controller 100a manages a plurality of first L2P tables 311. The controller 100a stores the correspondence relation between a logical address specified by the host device 2 and a physical address indicating a storage destination of write data into a first L2P table 311 that differs for each group number.

In an example shown in FIG. 15, the controller 100a manages a first L2P table 311-1, a first L2P table 311-2, and a first L2P table 311-3. When the group number set in the field #3 of the write command is 01001, the controller 100a stores the correspondence relation between the logical address and the physical address into the first L2P table 311-1. When the group number set in the field #3 of the write command is 01002, the controller 100a stores the correspondence relation between the logical address and the physical address into the first L2P table 311-2. When the group number set in the field #3 of the write command is 01003, the controller 100a stores the correspondence relation between the logical address and the physical address into the first L2P table 311-3.

The host device 2 can use a common value as a group number when a plurality of vector information pieces Dv that are positionally close to one another are read. When the group number is used in this way, according to the modification 2, as in the modification 1, the L2P table 301 to be referred to when the plurality of vector information pieces Dv that are positionally close to one another can be made as common as possible. Since the L2P table 301 to be referred to when the plurality of vector information pieces Dv that are positionally close to one another is made as common as possible, it is possible to enhance the probability of a cache hit in the data cache area 420 when reading of the plurality of vector information pieces Dv is sequentially requested from the host device 2. Therefore, the reading performance as seen from the host device 2 when the host device 2 performs the processing is improved.

While certain embodiments have been described, these embodiments have been presented by way of example only, and are not intended to limit the scope of the inventions. Indeed, the novel devices and methods described herein may be embodied in a variety of other forms; furthermore, various omissions, substitutions, and changes in the form of the embodiments described herein may be made without departing from the spirit of the inventions. The accompanying claims and their equivalents are intended to cover such forms or modification as would fall within the scope and spirit of the inventions.

What is claimed is

1. A memory system connectable to a host device, comprising:
a first memory device, which is a non-volatile memory including a first memory cell region assigned with a first consecutive physical address range and a second memory region separate from the first memory cell region and assigned with a second consecutive physical address range that is separate from the first consecutive physical address range; and
a controller configured to store vector information received from the host device in the first memory cell region and not in the second memory cell region, and store non-vector information received from the host device in the second memory cell region and not in the first memory cell region.

2. The memory system according to claim 1, further comprising:
a second memory device provided separately from the first memory device, the second memory device including a first cache region, and
the controller is configured to:
maintain, in the first memory device, mapping information indicating logical-physical address correspondence for the first and second memory cell regions, the mapping information being divided into a plurality of mapping segments, each of which corresponds to a subdivided physical address range in the first or second memory cell region; and
selectively store a part of the mapping segments in the first cache region of the second memory device.

3. The memory system according to claim 2, wherein the controller is configured to:
determine whether or not a logical address designated by a read command received from the host device is mapped in the part of the mapping segments stored in the first cache region;
when the logical address is mapped in the part of the mapping segments stored in the first cache region, determine a physical address of the first memory device corresponding to the logical address using the part of the mapping segments stored in the first cache region; and
when the logical address is not mapped in the part of the mapping segments stored in the first cache region, read a mapping segment that maps the logical address from the first memory device and determine the physical address of the first memory device corresponding to the logical address using the mapping segment read from the first memory device.

4. The memory system according to claim 2, wherein
the second memory device further includes a second cache region, and
the controller is configured to:
store, in the second cache region, a selected part of data stored in the first and second memory regions of the first memory device;
read data requested to be read by a read command received from the host device, from the second cache region when the requested data is stored in the second cache region; and
read the requested data from the first memory device when the requested data is not stored in the second cache region.

5. The memory system according to claim 4, wherein the controller is configured to:
determine whether or not a logical address designated by the read command is mapped in the part of the mapping segments stored in the first cache region, when the data requested to be read by the read command is not stored in the second cache region;
when the logical address is mapped in the part of the mapping segments stored in the first cache region, determine a physical address of the first memory device corresponding to the logical address using the part of the mapping segments stored in the first cache region; and
when the logical address is not mapped in the part of the mapping segments stored in the first cache region, read a mapping segment that maps the logical address from the first memory device and determine the physical address of the first memory device corresponding to the logical address using the mapping segment read from the first memory device.

6. The memory system according to claim 1, wherein the controller is configured to determine whether write data corresponding to a write command received from the host device is the vector information or the non-vector information based on a first parameter value included in the write command.

7. The memory system according to claim 6, wherein
the first consecutive physical address range includes a plurality of subdivided physical address ranges, and
the controller is configured to determine a physical address of the first memory device at which the write data is to be written based on the first parameter value when the first parameter value indicates that the write data is the vector information.

8. The memory system according to claim 6, wherein
the first memory device stores mapping information indicating logical-physical address correspondence for the first and second memory cell regions, the mapping information being divided into a plurality of mapping segments, each of which corresponds to a subdivided physical address range in the first or second memory cell region, and
the controller is configured to update one of the mapping segments in the first memory device after writing the write data at the determined physical address of the first memory device.

9. The memory system according to claim 8, wherein at least one of the subdivided physical address ranges of the first consecutive physical address range spans ranges mapped by two or more of the mapping segments.

10. The memory system according to claim 1, wherein the first memory cell region is smaller than the second memory cell region.

11. A memory system connectable to a host device, comprising:
a first memory device, which is a non-volatile memory including a memory cell region assigned with a physical address range;
a second memory device provided separately from the first memory device, the second memory device including a first cache region; and
a controller configured to:
maintain, in the first memory device, mapping information indicating logical-physical address correspondence for the memory cell region, the mapping information being separated into a first mapping segment for vector information and a second mapping segment for non-vector information;
selectively store a part of the mapping information in the first cache region of the second memory device; and
store address mapping for vector information received from the host device in the first mapping segment and not in the second mapping segment and address mapping for non-vector information received from the host device in the second mapping segment and not in the first mapping segment.

12. The memory system according to claim 11, wherein the controller is configured to store vector information and non-vector information in the memory cell region in a commingled manner.

13. The memory system according to claim 11, wherein the controller is configured to:
determine whether or not a logical address designated by a read command received from the host device is mapped in the part of the mapping information stored in the first cache region;
when the logical address is mapped in the part of the mapping information stored in the first cache region, determine a physical address of the first memory device corresponding to the logical address using the part of the mapping information stored in the first cache region; and
when the logical address is not mapped in the part of the mapping information stored in the first cache region, read another part of the mapping information that maps the logical address from the first memory device and determine the physical address of the first memory device corresponding to the logical address using said another part of the mapping information read from the first memory device.

14. The memory system according to claim 13, wherein
the second memory device further includes a second cache region, and
the controller is configured to:
store, in the second cache region, a selected part of data stored in the first and second memory regions of the first memory device;
read data requested to be read by the read command received from the host device, from the second cache region when the requested data is stored in the second cache region; and
read the requested data from the first memory device when the requested data is not stored in the second cache region.

15. The memory system according to claim 11, wherein the controller is configured to determine whether write data corresponding to a write command received from the host device is vector information or non-vector information based on a first parameter value included in the write command.

16. The memory system according to claim 15, wherein
the first mapping segment is subdivided into a plurality of first mapping subsegments, and
the controller is configured to determine one of the first mapping subsegments in which the address mapping for the vector information received from the host device is to be stored based on the first parameter value included in the write command.

17. The memory system according to claim 11, wherein
the first mapping segment includes a plurality of first mapping subsegments, and the second mapping segment includes a plurality of second mapping subsegments, and
the controller is configured to selectively store a part of the first mapping subsegments and a part of the second mapping subsegments in the first cache region of the second memory device.

18. The memory system according to claim 17, wherein the controller is configured to:
determine whether or not data requested to be read by a read command received from the host device is vector information or non-vector information based on a second parameter value included in the read command;
refer to the part of the first mapping subsegments in the first cache region to determine whether address mapping for vector information received from the host device is cached in the first cache region, when determining that the requested data is vector information; and
refer to the part of the second mapping subsegments in the first cache region to determine whether address mapping for non-vector information received from the host device is cached in the first cache region, when determining that the requested data is non-vector information.
